(19) United States
(12) Patent Application Publication
(10) Pub. No.: US 2005/0076375 A1
(43) Pub. Date: Apr. 7, 2005

(54) Data transmission apparatus and power supply control method for use in the same

(76) Inventor: Masao Nakamura, Akishima-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/922,740

(22) Filed: Aug. 20, 2004

(30) Foreign Application Priority Data
Aug. 27, 2003 (JP) 2003-303113

(51) Int. Cl. H04N 7/18

(52) U.S. Cl. 725/81; 725/80

(57) ABSTRACT

According to one embodiment of the invention, a data transmission apparatus is adapted with a function for receiving broadcast data in response to a request from a terminal and for controlling a supply of power to different units of the data transmission apparatus. The data transmission apparatus comprises a power supply unit, a first receiving unit, a second receiving unit and a communication unit to support communications between an external network and a local network including a plurality of terminals. The data transmission apparatus further comprises a system control unit and optionally a power supply control unit for controlling the power supply unit based on states of use of the first receiving unit and the second receiving unit by individually powering on/off the first receiving unit and the second receiving unit while the communication unit is powered on.

### CROSS-REFERENCE TO RELATED APPLICATIONS

This application is based upon and claims the benefit of priority from the prior Japanese Patent Application No. 2003-303113, filed Aug. 27, 2003, the entire contents of which are incorporated herein by reference.

### BACKGROUND

1. Field

The present invention relates generally to a data transmission apparatus such as a home server, and more particularly to a data transmission apparatus having a function of receiving broadcast data such as a TV broadcast program data in response to a request from a terminal, and a power supply control method for use in the apparatus.

2. Description of the Related Art

In recent years, information processing technology and networking technology have developed remarkably. With this development, a home network system has been developed for connecting household electronic apparatuses such as a TV and audio equipment.

In the home network system, a home server is connected over a network to a client terminal such as a personal computer. Recently, a home server with a router function for connecting a local network, to which the client terminal is connected, and an external network such as the Internet, has been developed. The client terminal can communicate via the home server with some other client terminal within the home and a Web server on the Internet.

Further, a home server with a TV function for receiving broadcast data such as TV broadcast program data has been developed. The home server can output received broadcast data to an external TV receiver, and can also transmit the received broadcast data to the client terminal over the local network.

During power-on time of the conventional home server, power is always supplied to both a router unit and a broadcast program data receiving unit. While only the router function of the home server is being used, power is wastefully consumed by the supply of power to the broadcast program data receiving unit.

In order to enable a plurality of client terminals to use the TV function of the home server at the same time, it is necessary to provide the home server with a plurality of broadcast program data receiving units. In this case, however, power is always supplied to the router unit and all the broadcast program data receiving units while the home server is in the power-on state. It is highly possible that more power is wastefully consumed.

Jpn. Pat. Appln. KOKAI Publication No. 10-108115 discloses a method of turning off power to a non-used one of a plurality of TV tuners (a terrestrial tuner and a broadcasting satellite [BS] tuner). In this method, in accordance with the user's operation of a key switch or a remote control unit, a TV tuner, whose output is to be used, is explicitly designated. Power to the designated TV tuner is turned on.

However, the above method presupposes that a dedicated video apparatus is used in a single-user environment. No consideration is given to a multi-user environment in which a plurality of users individually control the TV function of the home server from their own client terminals. In the case of a home server that can communicate with a plurality of client terminals, it is necessary to realize a scheme for using the communication function and TV function of the home server from a plurality of terminals, without causing wasteful power consumption.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an exemplary embodiment of the configuration of a home network system using a wireless AV station according to an embodiment of the present invention;

FIG. 2 is an exemplary block diagram showing the configuration of the wireless AV station shown in FIG. 1;

FIG. 3 is an exemplary block diagram showing an example of a power supply system that is provided in the wireless AV station shown in FIG. 1;

FIG. 4 shows an example of an AV path assignment table that is used in the wireless AV station shown in FIG. 1;

FIG. 5 illustrates an exemplary transition of the power-supply state of the wireless AV station shown in FIG. 1;

FIG. 6 is an exemplary flowchart illustrating the procedure of a power-on sequence control process that is executed by the wireless AV station shown in FIG. 1; and

FIG. 7 is an exemplary flowchart illustrating the procedure of a power-off sequence control process that is executed by the wireless AV station shown in FIG. 1.

### DETAILED DESCRIPTION

An embodiment of the present invention will now be described with reference to the accompanying drawings.

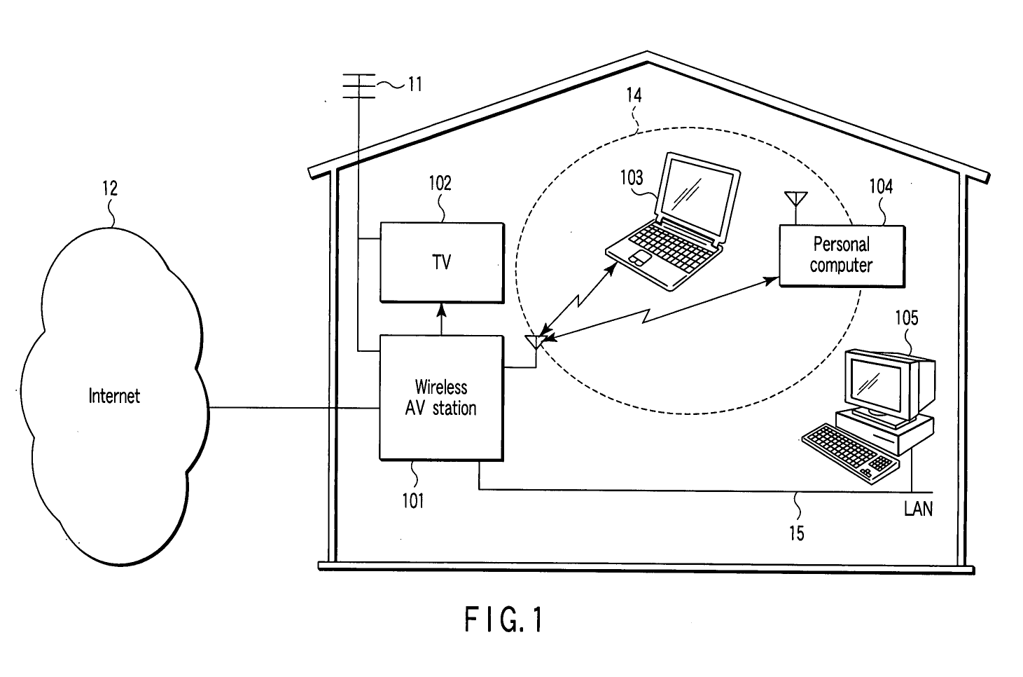

FIG. 1 shows an exemplary configuration of a home network system using a data transmission apparatus according to the embodiment of the present invention. The home network system includes a wireless audio-video (AV) station 101, a TV receiver 102, notebook personal computers 103 and 104, and a desktop personal computer 105.

The wireless AV station 101 is a data transmission apparatus functioning as a home server. The wireless AV station 101 offers services, such as viewing/listening of broadcast data (broadcast program data) of, e.g. TV programs, and Internet browsing, to the information processing terminals such as personal computers 103 to 105 over a household wireless or wired local network.

The wireless AV station 101 is connected to an external global network (external network) such as the Internet 12 via a communication line. The communication line is, for example, an ISDN (Integrated Services Digital Network), an ADSL (Asymmetric Digital Subscriber Line) or a CATV (Cable TV). Further, the wireless AV station 101 is connected to the respective the personal computers 103 to 105 over the household wireless or wired network.

For this embodiment of the invention, each of the personal computers 103 to 105 is an information processing terminal functioning as a client of the wireless AV station 101. Each of the notebook personal computers 103 and 104 is equipped with a wireless communication device. Thereby, each of the notebook personal computers 103 and 104 can be connected to the wireless AV station 101 via a wireless communication network (wireless LAN) 14. In addition, the desktop personal computer 105 is connected to the wireless AV station 101 via a wired communication network (wired LAN) 15.

The wireless AV station 101 connects each of the personal computers 103 to 105 to the Internet 12, and supports data transmissions between a Web site on the Internet 12 and each of the personal computers 103 to 105.

An antenna cable connected to an outdoor TV broadcast receiving antenna 11 is led into the house. The TV receiver 102 and wireless AV station 101 are connected to the antenna cable. Broadcast data sent from a broadcast station can be received and reproduced by the TV receiver 102 and can also be received by the wireless AV station 101. The wireless AV station 101 transmits the received broadcast data to each of the personal computers 103, 104, 105 via the household wireless or wired local network. In addition, the wireless AV station 101 can output the received broadcast data to the TV receiver 102.

The main functions that are provided by the wireless AV station 101 are as follows.

Router Function

The router function is a function for connecting the household wireless local network 14 or wired local network 15 and the Internet 12. Using the router function, each of the personal computers 103 to 105 can communicate with a Web site on the Internet 12 and can communicate with some other personal computer on the local network.

TV Function

The TV function is a function for receiving broadcast program data in response to a request from each of the personal computers 103 to 105, which is connected to the household wireless or wired local network 14, 15. The wireless AV station 101 can transmit the received broadcast program data to the requesting personal computer, or output the received broadcast program data to the TV 102. The wireless AV station 101 includes a plurality of broadcast program data receiving units so that a plurality of information processing terminals can use the TV function at the same time.

TV Recording Function

The wireless AV station 101 includes a magnetic disk drive unit (hard disk drive [HDD]) as a large-capacity storage device for recording broadcast program data. The wireless AV station 101, for example, can record currently broadcast program data in the magnetic disk drive unit as a file, while transmitting the broadcast program data to the information processing terminal. In addition, the wireless AV station 101 can receive other currently broadcast program data and record it in the magnetic disk drive unit, while transmitting the broadcast program data already stored in the magnetic disk drive unit to the information processing terminal. Furthermore, the wireless AV station 101 can output the broadcast program data stored in the magnetic disk drive unit to the TV receiver 102.

Content Server Function

In response to a data acquisition request from each of the personal computers 103 to 105, the wireless AV station 101 can transmit to the requesting personal computer the broadcast program data, which is recorded in the magnetic disk drive unit as a file.

Remote Control Function

The TV function, TV recording function and content server function of the wireless AV station 101 can be remote-controlled from each of the personal computers 103 to 105. In addition, a dedicated remote control unit for operating the wireless AV station 101 may be used to control the TV function, TV recording function and content server function of the wireless AV station 101.

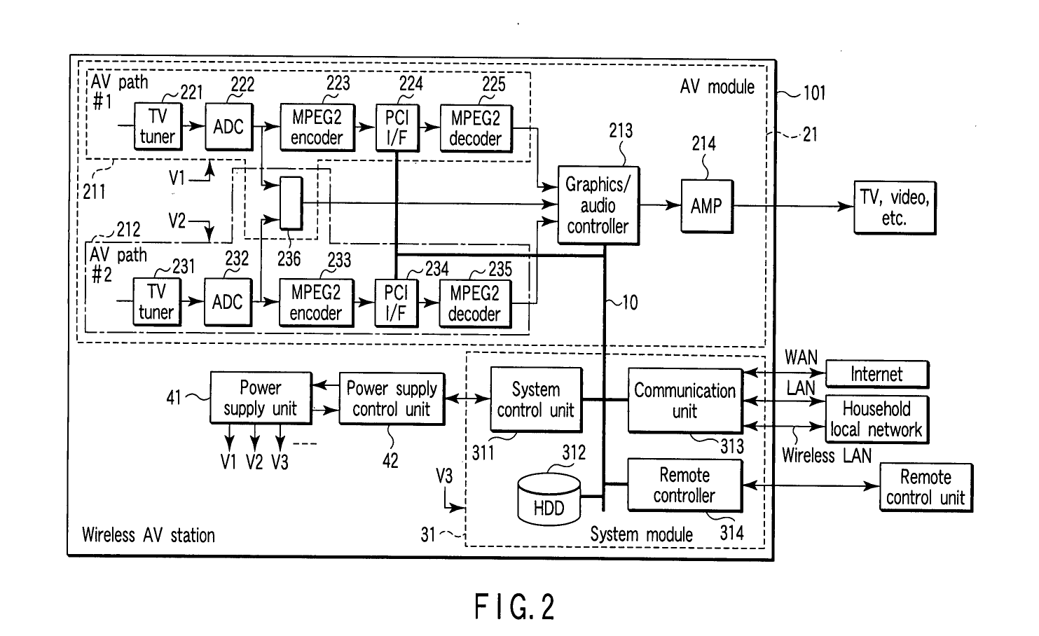

Next, referring to FIG. 2, the system configuration of the wireless AV station 101 is described.

The wireless AV station 101, as shown in FIG. 2, includes an AV (Audio-Video) module 21, a system module 31, a power supply unit 41 and a power supply control unit 42. The AV module 21 executes the above-described TV function and TV recording function. The AV module 21 includes a first AV path 211, a second AV path 212, a graphics/audio controller 213 and an amplifier (AMP) 214. The AV module 21 is connected to the system module 31 via a bus 10 such as a PCI (Peripheral Component Interconnect) bus for example. The first and second AV paths 211 and 212 are receiving units for receiving broadcast program data, which is requested from each information processing terminal. The first and second AV paths 211 and 212 are driven by mutually independent power outputs V1 and V2. The power outputs V1 and V2 are power supply voltages supplied from the power supply unit 41, and are supplied to the first and second AV paths 211 and 212 as operational power. The two AV paths 211 and 212 can offer the TV function or the TV recording function to two information processing terminals at the same time.

The graphics/audio controller 213 is an output device for outputting broadcast program data such as TV broadcast program data to the external TV receiver 102 or AV equipment. The graphics/audio controller 213 outputs to the external TV receiver 102 or AV equipment the broadcast program data that is received by the AV path 211 or 212, or the broadcast program data that is stored in an HDD 312 of the system module 31.

The first AV path 211 includes a TV tuner 221, an analog-to-digital converter (ADC) 222, an MPEG2 (MPEG: Moving Picture Coding Experts Group/Moving Picture Experts Group) encoder 223, a PCI bus interface (PCI I/F) 224, and an MPEG2 decoder 225. The tuner 221 is connected to the TV antenna 11 for receiving broadcast program data, or CATV network for supplying broadcast program data. The tuner 221 is a device that receives broadcast program data on a channel, listening/viewing of which is requested from the personal computer 103, 104, 105 or a remote control unit. Based on a TV reception request (request for TV listening/viewing), the TV tuner 221 receives TV broadcast signals and selects the channel. The analog-to-digital converter (ADC) 222, MPEG2 encoder 223, PCI bus interface (PCI I/F) 224 and MPEG2 decoder 225 constitute a broadcast data processing unit that processes the TV broadcast program data that is received by the TV tuner 221. TV broadcast program data on a certain channel, which is received by the TV tuner 221, is sent to the analog-to-digital converter (ADC) 222 and converted from an analog signal to a digital signal.

In the case where the TV broadcast program data that is received by the TV tuner 221 is output to the TV receiver 102, the converted TV broadcast data in digital signal form is sent to the graphics/audio controller 213 via a selector 236. On the other hand, in the case where the TV broadcast program data that is received by the TV tuner 221 is sent to the requesting information processing terminal or recorded in the HDD 312 in the system module 31, the converted TV broadcast data in digital signal form is delivered to the MPEG2 encoder 223. The MPEG2 encoder 223 compression-encodes the TV broadcast program data. The compression-encoded TV broadcast program data is delivered to the system module 31 via the PCI bus interface (PCI I/F) 224 and bus 10. In the case of recording the TV broadcast program data, which is received by the TV tuner 221, in the HDD 312 in the system module 31 while outputting it to the TV receiver 102, the TV broadcast program data that is converted to the digital signal by the analog-to-digital converter (ADC) 222 is supplied to both the selector 236 and MPEG2 encoder 223.

The MPEG2 decoder 225 decodes the compression-encoded TV broadcast program data. The MPEG2 decoder 225 is used in the case of outputting the compression-encoded TV broadcast program data, which is recorded in the HDD 312 in the system module 31, to the TV receiver 102. In this manner, the first AV path 211 executes the reception process for broadcast data and the broadcast data process for recording and reproducing the received broadcast data.

The second AV path 212, like the first AV path 211, includes a TV tuner 231, an analog-to-digital converter (ADC) 232, an MPEG2 encoder 233, a PCI bus interface (PCI I/F) 234, and an MPEG2 decoder 235. The tuner 231 is a device that receives broadcast program data of a channel, listening/viewing of which is requested from the personal computer 103, 104, 105 or the remote control unit. Based on the TV reception request (request for TV listening/viewing), the TV tuner 231 effects reception of TV broadcast signals and selection of the channel. The analog-to-digital converter (ADC) 232, MPEG2 encoder 233, PCI bus interface (PCI I/F) 234 and MPEG2 decoder 235 constitute a broadcast data processing unit that processes the TV broadcast program data that is received by the TV tuner 231. TV broadcast program data on a certain channel, which is received by the TV tuner 231, is sent to the analog-to-digital converter (ADC) 232 and converted from an analog signal to a digital signal.

In the case where the TV broadcast program data that is received by the TV tuner 231 is output to the TV receiver 102, the converted TV broadcast data in digital signal form is sent to the graphics/audio controller 213 via the selector 236. On the other hand, in the case where the TV broadcast program data that is received by the TV tuner 231 is sent to the requesting information processing terminal or recorded in the HDD 312 in the system module 31, the converted TV broadcast data in digital signal form is delivered to the MPEG2 encoder 233. The MPEG2 encoder 233 compression-encodes the TV broadcast program data. The compression-encoded TV broadcast program data is delivered to the system module 31 via the PCI bus interface (PCI I/F) 234 and bus 10. In the case of recording the TV broadcast program data, which is received by the TV tuner 231, in the HDD 312 in the system module 31 while outputting it to the TV receiver 102, the TV broadcast program data that is converted to digital signal form by the analog-to-digital converter (ADC) 232 is supplied to both the selector 236 and MPEG2 encoder 233.

The MPEG2 decoder 235 decodes the compression-encoded TV broadcast program data. The MPEG2 decoder 235 is used in the case of outputting the compression-encoded TV broadcast program data, which is recorded in the HDD 312 in the system module 31, to the TV receiver 102. In this manner, the second AV path 212 executes the reception process for broadcast data and the broadcast data process for recording and reproducing the received broadcast data.

The system module 31 includes a system control unit 311, HDD 312, a communication unit 313 and a remote controller 314. The system control unit 311, HDD 312, communication unit 313 and remote controller 314 are driven by a power output V3 supplied from the power supply unit 41. In general, the power output V3 is a power supply voltage for use as operational power by the system module 31. The system control unit 311 is a processor that controls the operation of the wireless AV station 101. The system control unit 311 controls the operation of the AV module 21 in accordance with a TV data viewing/listening request, which is received via the remote controller 314 from the remote control unit, and a TV data viewing/listening request, which is received from each of the personal computers 103 to 105, via the communication unit 313. The system control unit 311 has a monitor function for monitoring the states of use of the AV paths 211 and 212, and a power supply control function for individually controlling power-on/off of the AV path 211 and the power-ON/OFF of the AV path 212 through the power supply control unit 42 so as to turn off the power to the AV path that is not currently used.

The communication unit 313 is a device for executing the above-mentioned router function. The communication unit 313 supports data transmissions between a household local network (wireless LAN 14, wired LAN 15) and the Internet 12. The communication unit 313 includes an IP masquerade function, a NAT (Network Address Translation) function and a DHCP (Dynamic Host Configuration Protocol) function. The communication unit 313 includes a WAN (Wide Area Network) terminal for connection to the Internet 12, a wireless communication device for execution of communication with the wireless LAN 14, and a LAN (Local Area Network) terminal for connection to the wired LAN 15. The communication unit 313 supports data communications between the personal computers 103 to 105 over the household local network (wireless LAN 14, wired LAN 15) and data communication between each of the personal computers 103 to 105 and the Internet 12. The communication unit 313 is connected to the system control unit 311 via the bus 10. If the communication unit 313 receives a TV data viewing/listening request from any one of the personal computers 103 to 105, the communication unit 313 transmits the received TV data viewing/listening request to the system control unit 311. In addition, the communication unit 313 has a function of transmitting, under control of the system control unit 311, the TV broadcast program data, which is received by the AV module 21, to each of the personal computers 103 to 105 via the local network.

The remote controller 314 enables communications with the remote control unit. A TV viewing/listening request sent from the remote control unit is received by the remote controller 314 and delivered to the system control unit 311 via the bus 10.

The power supply unit 41 is a power supply device that supplies operational power to the respective components, which constitute the wireless AV station 101. The power supply unit 41 independently controls the supply of power V1 to the first AV path 211, the supply of power V2 to the second AV path 212 and the supply of power V3 to the system module 31 in accordance with a power supply control signal from the power supply control unit 42. The power supply control unit 42 delivers a power supply control signal to the power supply unit 41 in accordance with a request from the system control unit 311. In addition, the power supply control unit 42 monitors the operation of the power supply unit 41 by means of a power supply status signal from the power supply unit 41, thereby to detect occurrence of abnormality in power supply.

In the wireless AV station 101, the supply of power V3 to the communication unit 313, which functions as the router, and the supply of power outputs V1 and V2 to the first and second AV paths 211 and 212 can be independently controlled. If the content server function and Web browsing function are used and the TV function and TV recording function are not used, the supply of power outputs V1 and V2 to the first and second AV paths 211 and 212 can be stopped while power V3 is being supplied to the communication unit 313. Furthermore, in the wireless AV station 101, it is possible to independently control the supply of power V1 to the AV path 211 and the supply of power V2 to the AV path 212. On the basis of the states of use of the first and second AV paths 211 and 212, the power-on/off of the first AV path 211 and second AV path 212 can be individually controlled and power can be supplied to only the AV path that requires power supply. For example, in the case where only one terminal uses the TV function/TV recording function, power is supplied to only one of the first and second AV paths 211 and 212. If two terminals simultaneously use the TV function/TV recording function, power is supplied to both the first and second AV paths 211 and 212.

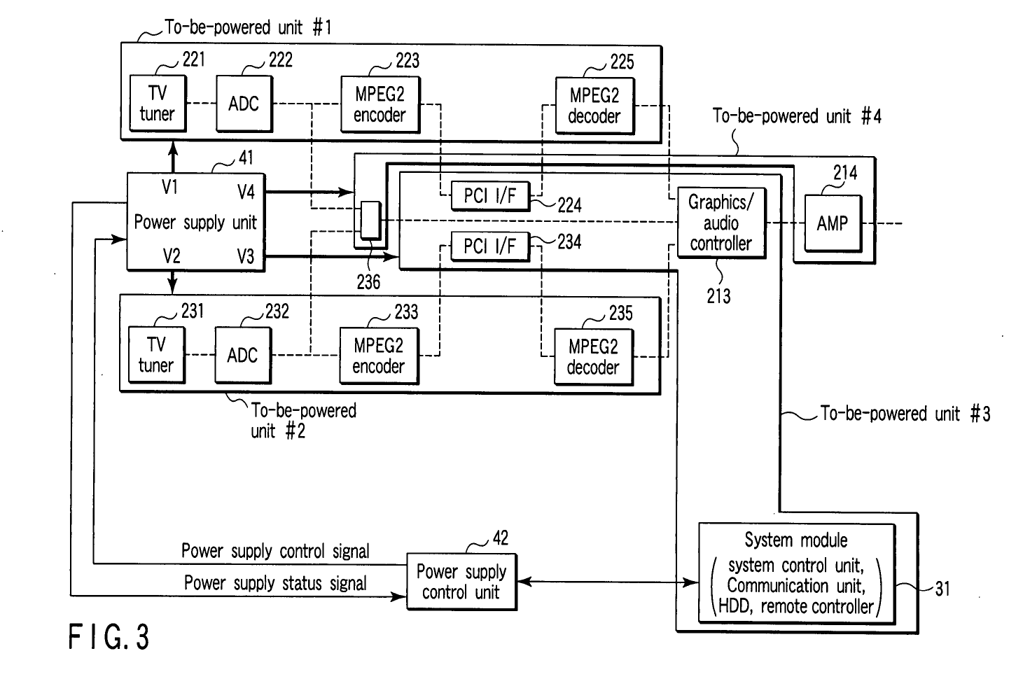

Next, referring to FIG. 3, a specific power supply system that is provided in the wireless AV station 101 is described.

The components of the wireless AV station 101 are classified into first to fourth “to-be-powered” units (four in total). The TV tuner 221, analog-to-digital converter (ADC) 222, MPEG2 encoder 223 and MPEG2 decoder 225 in the first AV path 211 belong to the first to-be-powered unit. The power V1 is supplied as operational power to these components. The TV tuner 231, analog-to-digital converter (ADC) 232, MPEG2 encoder 233 and MPEG2 decoder 235 in the second AV path 212 belong to the second to-be-powered unit. The power output V2 is supplied as operational power to these components. The components directly connected to the bus 10, that is, the system module 31 (system control unit 311, HDD 312, communication unit 313 and remote controller 314), graphics/audio controller 213, PCI bus interface (PCI I/F) 224 in the first AV path 211 and PCI bus interface (PCI I/F) 234 in the second AV path 212, belong to the third to-be-powered unit. The power output V3 is supplied as operational power to these components. The components that are used to output broadcast program data to the TV 102, that is, the selector 236 and amplifier (AMP) 214, belong to the fourth to-be-powered unit. The power output V4 is supplied as operational power to these components.

The power supply unit 41 can independently control the supply of a plurality of power outputs denoted by V1, V2, V3 and V4. The power supply unit 41 includes four power output sections corresponding to the power outputs V1, V2, V3 and V4. For example, in accordance with a power supply control signal from the power supply control unit 42, switch circuits provided in the four power output sections are selectively on/off controlled, thereby individually on/off controlling the power outputs V1, V2, V3 and V4. While the wireless AV station 101 is being turned on, the power output V3 is supplied to the third to-be-powered unit. The power outputs V1, V2 and V4 are turned on/off, where necessary.

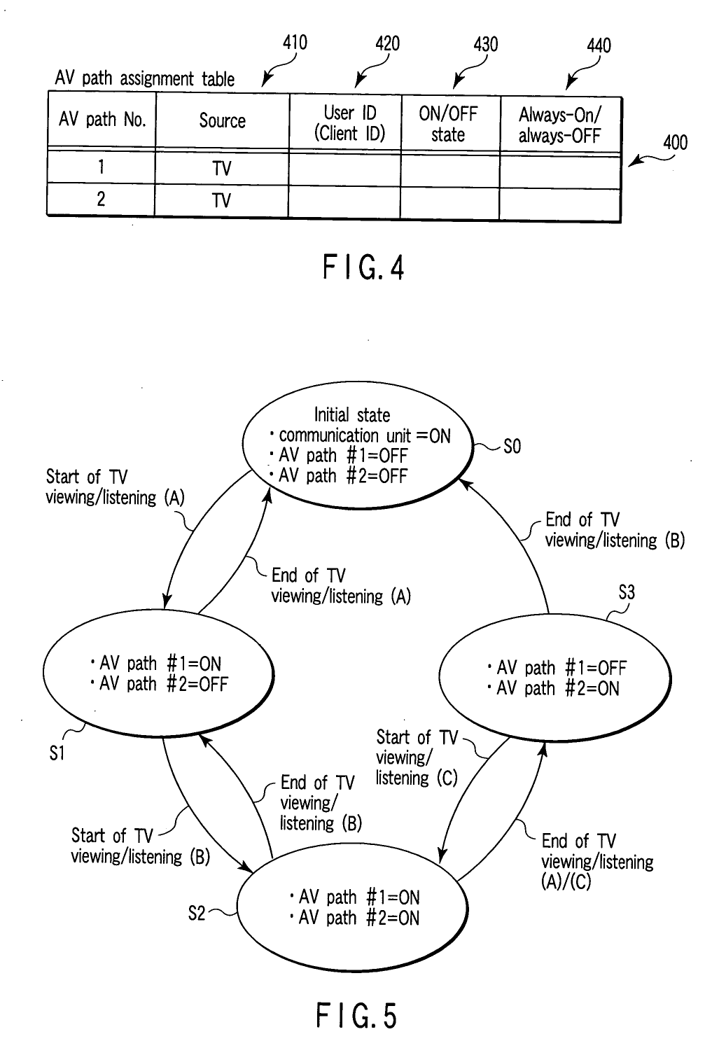

FIG. 4 shows an example of an AV path assignment table 400, which the system control unit 311 uses in order to manage the states of use of the AV paths 211 and 212. The AV path assignment table 400 stores information representative of “SOURCE” 410, “USER ID” 420, “ON/OFF STATE” 430 and “ALWAYS-ON/ALWAYS-OFF” 440 in connection with each of the AV path numbers. Table entry “SOURCE” 410 indicates the kind of source data (TV) corresponding to the associated AV path. Table entry “USER ID” 420 indicates an ID (client ID) that identifies the terminal using the associated AV path. For instance, the device ID, which is assigned to each of the information processing terminals 103 to 105 and remote control unit, is used as the client ID. Table entry “ON/OFF STATE” 430 indicates whether the associated AV path is currently in use, that is, whether the current power supply state of the associated AV path is on or off. Table entry “ALWAYS-ON/ALWAYS-OFF” 440 is setting information that is used when the associated AV path is set in an always-on state or an always-off state.

Next, referring to FIG. 5, a description is given of how the power supply state transits in the communication unit 313, first AV path 211 and second AV path 212.

If the wireless AV station 101 is powered on, the power supply state of the wireless AV station 101 is set in state S0 (initial state). In the state S0, power output V3 is supplied to the communication unit 313. However, power outputs V1 and V2 are not supplied to the associated first AV path 211 and second AV path 212. Specifically, when power to the wireless AV station 101 is turned on, only the power output V3 is supplied to the third to-be-powered unit while power to the first AV path 211 and second AV path 212 is turned off. When the wireless AV station 101 functions only as the router or when the wireless AV station 101 functions to transmit the broadcast program data, which is recorded in the HDD 312, to the information processing terminal via the communication unit 313, the AV module 21 is not used. Thus, the wireless AV station 101 is maintained in the state S0.

If the communication unit 313 receives, in the state S0, a TV viewing/listening request (A) from a certain terminal (e.g. terminal of ID=A) over the local network, the power supply state transits to a state S1 (first AV path=on, second AV path=off). In the state S1, although power is supplied to the first AV path 211, no power is supplied to the second AV path 212. Power is supplied to the communication unit 313. Specifically, when the TV viewing/listening request (A) is received, a currently non-used first AV path 211 is assigned to the terminal (ID=A), which has sent the TV viewing/listening request (A), as the receiving device for receiving broadcast program data designated by the terminal (ID=A) that has sent the TV viewing/listening request (A). Then, the supply of power V1 is started to the first to-be-powered unit that corresponds to the first AV path 211 assigned to the terminal (ID=A). Thereby, the first AV path 211 is powered on. The broadcast program data that is received by the AV path 211 is sent to the terminal (ID=A) via the communication unit 313 or output to the TV 102. When the broadcast program data is output to the TV 102, the supply of power V4 to the fourth to-be-powered unit is also started and the selector 236 and amplifier 214 are powered on. Whether the broadcast program data is to be output to the terminal (ID=A) or to the TV 102 is designated by the TV viewing/listening request (A). If the TV viewing/listening request (A) calls for recording, the broadcast program data that is received by the AV path 211 is recorded in the HDD 312.

If the terminal (ID=A) transmits a TV viewing/listening end request in the state S1, the AV path 211 that is assigned to the terminal (ID=A) is powered off and the power supply state is returned to the state S0. On the other hand, if the communication unit 313 receives, in the state S1, a TV viewing/listening request (B) from another terminal (e.g. terminal of ID=B) over the local network, the power supply state transits from the state S1 to a state S2 (first AV path=on, second AV path=on). Specifically, when the TV viewing/listening request (B) is received, a currently non-used second AV path 212 is selected and assigned to the terminal (ID=B) as the receiving device for receiving broadcast program data designated by the terminal (ID=B) that has sent the TV viewing/listening request (B). Then, the supply of power V2 is started to the second to-be-powered unit that corresponds to the second AV path 212. Thereby, the second AV path 212 is powered on. The power-on state of the first AV path 211 is maintained and also the power-on state of the communication unit 313 is maintained. The broadcast program data that is received by the second AV path 212 is sent to the terminal (ID=B) via the communication unit 313 or output to the TV 102. If the TV 102 is already used by the TV viewing/listening request (A), the broadcast program data that is received by the AV path 212 cannot be output to the TV 102. If the TV viewing/listening request (B) calls for recording, the broadcast program data that is received by the AV path 212 is recorded in the HDD 312.

If the terminal (ID=B) transmits a TV viewing/listening end request in the state S2, the second AV path 212 that is assigned to the terminal (ID=B) is powered off and the power supply state is returned to the state S1.

On the other hand, if the terminal (ID=A) transmits a TV viewing/listening end request in the state S2, the first AV path 211 that is assigned to the terminal (ID=A) is powered off and the power supply state transits to a state S3 (first AV path=off, second AV path=on). If the terminal (ID=B) transmits a TV viewing/listening end request in the state S3, the second AV path 212 that is assigned to the terminal (ID=B) is powered off and the power supply state transits to the state S0.

If the communication unit 313 receives, in the state S3, a TV viewing/listening request (C) from some other terminal (e.g. terminal of ID=C) over the local network, the power supply state transits from the state S3 to the state S2. In the state S2, in order to receive broadcast program data that is designated by the TV viewing/listening request (C), a currently non-used first AV path 211 is assigned to the terminal (ID=C). Then, the supply of power V1 is started to the first to-be-powered unit that corresponds to the first AV path 211, and the AV path 211 is powered on.

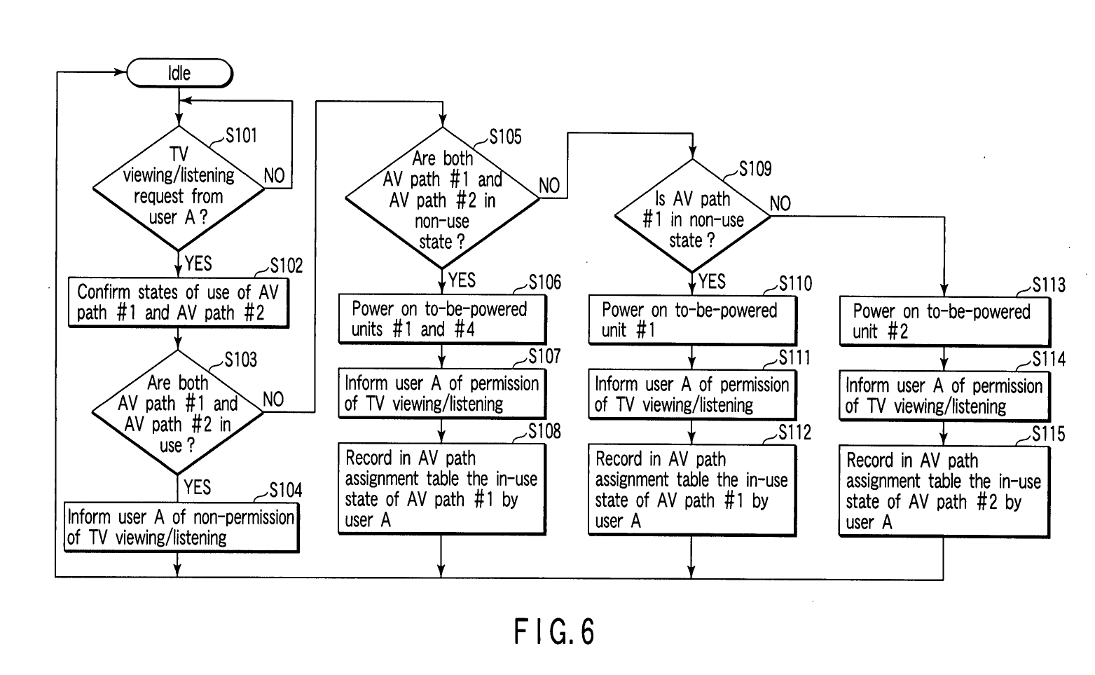

Next, referring to a flowchart of FIG. 6, a description is given of the power-ON sequence control process that is executed by the system control unit 311 in order to individually power on the first AV path 211 and second AV path 212.

If the communication unit 313 receives a TV viewing/listening request from a certain terminal (ID=A) (YES in block S101), the system control unit 311 refers to the AV path assignment table shown in FIG. 4 and checks the current states of use of the AV paths 211 and 212 (block S102). If both the first and second AV paths 211 and 212 are currently used (YES in block S103), the system control unit 311 sends a message indicative of non-permission of TV viewing/listening to the terminal (ID=A), which has sent the TV viewing/listening request, through communication between the terminal (ID=A) that has sent the TV viewing/listening request and the communication unit 313 (block S104).

On the other hand, if both the first and second AV paths 211 and 212 are in the non-use state (YES in block S105), the system control unit 311 assigns the first AV path 211 to the terminal (ID=A) as the AV path that is to be used for reception of broadcast program data designated by the terminal (ID=A). Then, the system control unit 311 controls the power supply unit 41 through the power supply control unit 42 so as to supply power to the first to-be-powered unit, which corresponds to the first AV path 211, and to the fourth to-be-powered unit (block S106). The system control unit 311 sends a message indicative of permission of TV viewing/listening to the terminal (ID=A), which has sent the TV viewing/listening request, through communication between the terminal (ID=A) that has sent the TV viewing/listening request and the communication unit 313 (block S107). Then, the system control unit 311 records, in the AV path assignment table, information indicative of the current use of the first AV path 211 by the terminal (ID=A) (block S108). In block S108, ID=A is registered in the [USER ID] field corresponding to the first AV path 211, and information indicative of on-state is registered in the [ON/OFF STATE] field corresponding to the first AV path 211.

If the first AV path 211 is in the non-use state and the second AV path 212 is in use (YES in block S109), the system control unit 311 assigns the first AV path 211 to the terminal (ID=A) as the AV path that is to be used for reception of broadcast program data designated by the terminal (ID=A). The system control unit 311 controls the power supply unit 41 through the power supply control unit 42 so as to supply power to the first to-be-powered unit that corresponds to the first AV path 211 (block S110). Then, the system control unit 311 sends a message indicative of permission of TV viewing/listening to the terminal (ID=A), which has sent the TV viewing/listening request, through communication between the terminal (ID=A) that has sent the TV viewing/listening request and the communication unit 313 (block S111). Thereafter, the system control unit 311 records, in the AV path assignment table, information indicative of the current use of the first AV path 211 by the terminal (ID=A) (block S112).

If the first AV path 211 is in use and the second AV path 212 is not in use (NO in block S109), the system control unit 311 assigns the second AV path 212 to the terminal (ID=A) as the AV path that is to be used for reception of broadcast program data designated by the terminal (ID=A). The system control unit 311 controls the power supply unit 41 through the power supply control unit 42 so as to supply power to the second to-be-powered unit that corresponds to the second AV path 212 (block S113). Then, the system control unit 311 sends a message indicative of permission of TV viewing/listening to the terminal (ID=A), which has sent the TV viewing/listening request, through communication between the terminal (ID=A) that has sent the TV viewing/listening request and the communication unit 313 (block S114). Thereafter, the system control unit 311 records, in the AV path assignment table 400 of FIG. 4, information indicative of the current use of the second AV path 212 by the terminal (ID=A) (block S115). In block S115, ID=A is registered in the [USER ID] field corresponding to the second AV path 212, and information indicative of on-state is registered in the [ON/OFF STATE] field corresponding to the second AV path 212.

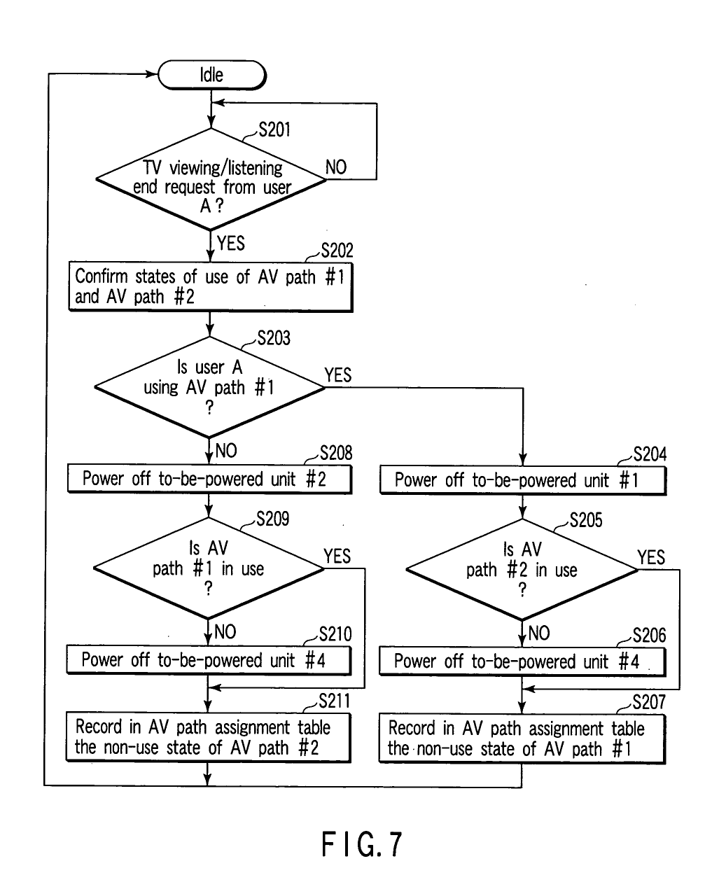

Next, referring to a flowchart of FIG. 7, a description is given of the power-off sequence control process that is executed by the system control unit 311 in order to individually power off the first AV path 211 and second AV path 212.

If the communication unit 313 receives a TV viewing/listening end request from a certain terminal (ID=A) (YES in block S201), the system control unit 311 refers to the AV path assignment table and determines whether the AV path that is assigned to and used by the terminal (ID=A), which has sent the TV viewing/listening end request, is the first AV path 211 or the second AV path 212 (block S202).

If the AV path that is used by the terminal (ID=A), which has sent the TV viewing/listening end request, is the first AV path 211 (YES in block S203), the system control unit 311 controls the power supply unit 41 through the power supply control unit 42 so as to stop the supply of power to the first to-be-powered unit that corresponds to the first AV path 211 (block S204). Then, the system control unit 311 determines, referring to the AV path assignment table, whether the second AV path 212 is in use (block S205). If the second AV path 212 is not in use, the power supply to the fourth to-be-powered unit is needless. Thus, the system control unit 311 controls the power supply unit 41 through the power supply control unit 42 so as to stop the supply of power to the fourth to-be-powered unit (block S206). Then, the system control unit 311 records, in the AV path assignment table, information indicative of the non-use state of the first AV path 211 (block S207). In block S207, the registered content in the [USER ID] field corresponding to the first AV path 211 is cleared, and information indicative of off-state is registered in the [ON/OFF STATE] field corresponding to the first AV path 211.

If the AV path that is used by the terminal (ID=A), which has sent the TV viewing/listening end request, is the second AV path 212 (NO in block S203), the system control unit 311 controls the power supply unit 41 through the power supply control unit 42 so as to stop the supply of power to the second to-be-powered unit that corresponds to the second AV path 212 (block S208). Then, the system control unit 311 determines, referring to the AV path assignment table, whether the first AV path 211 is in use (block S209). If the first AV path 211 is not in use, power supply to the fourth to-be-powered unit is needless. Thus, the system control unit 311 controls the power supply unit 41 through the power supply control unit 42 so as to stop the supply of power to the fourth to-be-powered unit (block S210). Then, the system control unit 311 records, in the AV path assignment table, information indicative of the non-use state of the second AV path 212 (block S211). In block S211, the registered content in the [USER ID] field corresponding to the second AV path 212 is cleared, and information indicative of off-state is registered in the [ON/OFF STATE] field corresponding to the second AV path 212.

As has been described above, according to the present embodiment, the power supply to the communication unit 313 and the power supply to each of the first and second AV paths 211 and 212 can independently be controlled. When the broadcast program receiving service not is used, for example, in such a case that the wireless AV station 101 functions only as the router or the broadcast program data recorded in the HDD 312 is being sent to the information processing terminal via the communication unit 313, it is possible to stop power supply to each of the first and second AV paths 211 and 212. Moreover, since a non-used one of the first and second AV paths 211 and 212 is automatically assigned to the terminal that transmits the broadcast program data reception request, the TV function/TV recording function can be used by the plural terminals 103 to 105, even without explicitly designating the AV path to be used. In this case, since the first and second AV paths 211 and 212 can individually be powered on/off in accordance with the states of use of the AV paths 211 and 212, power can be supplied to only the AV path that requires power supply. Without causing wasteful power consumption, the communication service and broadcast program receiving service can be offered to the plural terminals 103 to 105. In particular, the power supply to the entire AV path, which includes not only the TV tuner but also the broadcast data processing unit for processing broadcast data received by the TV tuner, is turned off until the AV path is assigned to the terminal that sends the broadcast data reception request. Therefore, compared to the case of turning off the power supply to only the TV tuner, further power saving can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A data transmission apparatus comprising:
a power supply unit;
a first receiving unit adapted to receive broadcast data, the first receiving unit being supplied a first power output by the power supply unit;
a second receiving unit adapted to receive broadcast data, the second receiving unit being supplied a second power output by the power supply unit;
a communication unit being supplied a third power output by the power supply unit, the communication unit supporting data transmissions with a plurality of terminals;
means for selectively assigning, in response to reception of a first request by the communication unit, one of the first receiving unit and the second receiving unit to one of the plurality of terminals having transmitted the first request, to enable the one of the first receiving unit and the second receiving unit to receive broadcast data that is designated by said one of the plurality of terminals having transmitted the first request; and
power supply control means for controlling the power supply unit based on states of use of the first receiving unit and the second receiving unit, to individually power on/off the first receiving unit and the second receiving unit while the communication unit is powered on.

2. The data transmission apparatus according to claim 1, wherein the power supply control means includes:
means for determining, in response to reception of a second request by the communication unit, which of the first receiving unit and the second receiving unit is assigned to one of the plurality of terminals which transmits the second request; and
means for powering off one of the first receiving unit and the second receiving unit, which is determined to be assigned to said one of the plurality of terminals that transmits the second request.

3. The data transmission apparatus according to claim 1, wherein the communication unit is configured to transmit the broadcast data, which is received by one of the first receiving unit and the second receiving unit that is assigned to the terminal that transmits the first request, via the local network to the terminal that transmits the first request.

4. The data transmission apparatus according to claim 1, further comprising:
an output device configured to output to an external electronic device broadcast data that is received by one of the first receiving unit and the second receiving unit, which is assigned to the terminal that transmits the first request.

5. The data transmission apparatus according to claim 1, further comprising:
a data storage device that stores broadcast data, which is received by one of the first receiving unit and the second receiving unit, which is assigned to the terminal that transmits the first request.

6. An apparatus comprising:
a power supply unit adapted to provide a plurality of power outputs;
a first receiving unit adapted to receive broadcast data, the first receiving unit being supplied with a first power output of the plurality of power outputs;
a second receiving unit adapted to receive broadcast data, the first receiving unit being supplied with a second power output of the plurality of power outputs;
a communication unit to support communications between a first network and a second network including a plurality of terminals, the communication unit being supplied with a third power output of the plurality of power outputs; and
a system control unit to control the power supply unit, based on states of use of the first receiving unit and the second receiving unit, in supplying the third power output to the communication unit and to control a supply of the first power output to the first receiving unit independently of whether the second power output is supplied to the second receiving unit.

7. The apparatus according to claim 6, wherein the system control unit operates in cooperation with a power supply control unit coupled to both the system control unit and the power supply unit.

8. The apparatus according to claim 6, wherein the system control unit controls the power supply unit to concurrently supply the first power output to the first receiving unit and the second power output to the second receiving unit.

9. The apparatus according to claim 6, wherein the system control unit controls the power supply unit to discontinue supplying both the first power output to the first receiving unit and the second power output to the second receiving unit.

10. The apparatus according to claim 6, wherein the first receiving unit comprises a first tuner to receive incoming broadcast data on a first selected channel for viewing.

11. The apparatus according to claim 10, wherein the second receiving unit comprises a second tuner and an encoder to encode incoming broadcast data on a second selected channel prior to storage within a data storage device.

12. A method of controlling a power supply unit of a wireless audio-video station including a plurality of receiving units adapted to receive broadcast data, and a communication unit supporting communications between an external network and a local network including a plurality of terminals, the method comprising:
supplying a third power output to drive the communication unit, while a first power output for driving the first receiving unit and a second power output for driving the second receiving unit are kept in a power-off state;
determining, in response to reception of a first request by the communication unit, whether one of the first receiving unit and the second receiving unit is in the power-off state;
assigning the first receiving unit in the power-off state to a first terminal of the plurality of terminals that transmitted the first request; and
supplying the first power output to the first receiving unit.

13. The method according to claim 12, further comprising:
determining, in response to reception of an end request by the communication unit, which of the plurality of receiving units is assigned to the first terminal transmitting the first request; and
discontinuing a supply of the first power output to the first receiving unit assigned to the first terminal transmitting the broadcast data reception end request.

14. The method according to claim 12, further comprising:
transmitting the broadcast data, received by the first receiving unit that is assigned to the first terminal transmitting the first request, via the local network to the first terminal.

15. The method according to claim 12, further comprising:
determining, in response to reception of a second request by the communication unit, whether one of the first receiving unit and the second receiving unit is in the power-off state;
assigning the second receiving unit in the power-off state to a second terminal of the plurality of terminals that transmitted the second request; and
supplying the second power output to the second receiving unit.

16. The method according to claim 15, further comprising:
storing the broadcast data, which is received by the second receiving unit, which is assigned to the second terminal into a data storage device that is provided in the wireless audio-video station.

17. A method comprising:
providing a plurality of audio-video (AV) paths including a first AV path and a second AV path; and
supplying power to each of the plurality of AV paths in response to (i) a request for broadcast data from a first terminal assigned to the first AV path and (ii) a request for broadcast data from a second terminal assigned to the second AV path.

18. The method according to claim 17, further comprising:
discontinuing a supply of power to each of the plurality of AV paths in response to receipt of end requests from the first terminal and the second terminal.

19. The method according to claim 17 further comprising:
supplying power to a communication unit independent of a power state of the first AV path and the second AV path, the communication unit being adapted to support communications between an external network and a local network including a plurality of terminals including the first terminal and the second terminal.

20. The method according to claim 17, wherein the broadcast data requested by the first terminal is different than the broadcast data requested by the second terminal.

21. The method according to claim 17, wherein the broadcast data requested by the first terminal is for display on a display.

22. The method according to claim 21, wherein the broadcast data requested by the second terminal is for recording on a storage device.

23. The method according to claim 17, wherein the broadcast data requested by the first terminal is for retrieval from a storage device and playback on a display.

24. The method according to claim 17, wherein the first AV path comprises a first tuner and a first broadcast data processing unit that processed the broadcast data received by the first tuner in response to the request for broadcast data from the first terminal.

25. The method according to claim 24, wherein the second AV path comprises a second tuner and a second broadcast data processing unit that processed the broadcast data received by the second tuner in response to the request for broadcast data from the second terminal.
